(19) United States
(12) Patent Application Publication
(10) Pub. No.: US 2026/0295616 A1
(43) Pub. Date: Oct. 1, 2026

(54) ATOMIZER TIP HAVING A ONE-WAY VALVE

(71) Applicant: ADVANCED MEDICAL ENGINEERING, LLC, SHERIDAN, WY (US)

(72) Inventors: JEFF PHIPPS, CEDAR CITY, UT (US); SCOTT SKEEN, CEDAR CITY, UT (US)

(21) Appl. No.: 19/631,555

(22) Filed: Mar. 27, 2026

Related U.S. Application Data
(60) Provisional application No. 63/780,061, filed on Mar. 28, 2025.

(51) Int. Cl. B05B 12/00; B05B 7/24; F16K 15/04

(52) U.S. Cl. CPC B05B 12/00; B05B 7/2416; B05B 17/04; F16K 15/044

(57) ABSTRACT

An atomizer tip, including: a body, comprising: a gas channel having an inlet and an outlet; a liquid channel having a proximal opening, a distal opening, and a liquid pathway extending therebetween, the liquid pathway comprising a horizontal lumen in communication with the distal opening and distal end, and a vertical lumen in communication with the proximal opening and the horizontal lumen; and a one-way valve disposed within the vertical lumen; and a cap coupled to the distal end of the body and comprising a nozzle, wherein an inner surface of the cap covers a portion of the distal opening of the liquid channel to form a distal wall and reduce a width of the distal opening, wherein an uncovered portion of the distal opening forms a terminal opening, and wherein the terminal opening and the outlet of the gas channel are aligned with the nozzle.

### RELATED APPLICATIONS

This application claims priority to U.S. Provisional Patent Application Ser. No. 63/780,061 filed on Mar. 28, 2025, which is hereby incorporated by reference in its entirety.

### FIELD OF THE INVENTION

The present invention relates generally to atomizer devices for use in discharging a liquid. More particularly, the present device relates to an atomizer tip device having a body and a cap, the body including channels for gas and liquid and a one-way valve disposed within the liquid channel.

### BACKGROUND OF THE INVENTION

Atomizer devices have been in use for many years to create a spray from a reservoir of a liquid. Early atomizer devices included a receptacle or container for a liquid that was attached to a gas tube and a liquid tube. The gas tube and the liquid tube communicated at their outward ends with a common spray head. A venturi effect was created by the spray head such that liquid was withdrawn from the receptacle through the liquid tube as gas passed through the gas tube, thereby forming a spray discharged from the atomizer.

Conventional atomizer devices tend to be large, inconsistent, and have the potential for backflow from the nozzle tip causing contamination to the liquid source. In medical settings, the large size of conventional atomizer tip designs may limit the use of the atomizer spray device to adult patients since conventional atomizer tip designs are not generally small enough to fit inside the nostril of a child or infant. Moreover, conventional tip designs do not provide for consistent fine spray droplets, which may be necessary for certain applications. Additionally, since liquid discharged from the tip of an atomizer device may be contaminated, especially if the tip is inserted into the mouth or nostril of a patient, it is important to prevent backflow into the liquid source. Furthermore, conventional atomizer tip designs are rigid, inflexible, and lack dynamic customization that allows for different kinds of spray profiles and may be adjusted for different applications and patients.

Accordingly, there is a need for a atomizer device having technical features and capabilities that are not currently achievable by existing devices. Such an atomizer device is disclosed herein.

### BRIEF SUMMARY OF THE INVENTION

The present invention relates generally to atomizer devices for use in discharging a liquid into or on the body of a patient. More particularly, the present device relates to an atomizer tip that includes a body, including: a proximal end; a distal end; a gas channel extending between the proximal end and the distal end, the gas channel having an inlet and an outlet; a liquid channel extending between the proximal end and the distal end, the liquid channel having a proximal opening, a distal opening, and a liquid pathway extending therebetween, the liquid pathway comprising a horizontal lumen in communication with the distal opening and distal end, and a vertical lumen in communication with the proximal opening and the horizontal lumen; and a one-way valve disposed within the vertical pathway; and a cap coupled to the distal end of the body and including a nozzle, wherein an inner surface of the cap covers a portion of the distal opening of the liquid channel to form a distal wall and reduce a width of the distal opening, wherein an uncovered portion of the distal opening forms a terminal opening and is in proximity to the outlet of the gas channel, and wherein the terminal opening and the outlet of the gas channel are aligned with the nozzle.

In some aspects of the present disclosure, a method of assembling the atomizer tip is provided, the method including disposing a ball into the liquid channel of the atomizer tip; inserting a spring into the liquid channel; and coupling the cap to the body, thereby providing fluid communication between the liquid channel and the gas channel via the nozzle of the cap.

### BRIEF DESCRIPTION OF THE DRAWINGS

In order that the above-recited and other features and advantages of the invention are obtained and will be readily understood, a more particular description of the invention briefly described above will be rendered by reference to specific embodiments thereof, which are illustrated in the appended drawings. These drawings depict only typical embodiments of the invention and are not therefore to be considered to limit the scope of the invention.

FIG. 1 is a perspective view of an atomizer device, in accordance with a representative embodiment of the present invention.

FIG. 2A is a front view of an atomizer tip, in accordance with a representative embodiment of the present invention.

FIG. 2B is a side view of an atomizer tip, in accordance with a representative embodiment of the present invention.

FIG. 2C is a front cross-sectional view of an atomizer tip, in accordance with a representative embodiment of the present invention.

FIG. 3A is an exploded perspective view of an atomizer tip, in accordance with a representative embodiment of the present invention.

FIG. 3B is an exploded side view of an atomizer tip, in accordance with a representative embodiment of the present invention.

FIG. 3C is an exploded cross-sectional view of an atomizer tip, in accordance with a representative embodiment of the present invention.

FIG. 3D is an exploded rear view of an atomizer tip, in accordance with a representative embodiment of the present invention.

FIGS. 4A-4D are each a perspective view of a body of an atomizer tip, in accordance with one or more representative embodiments of the present invention.

### DETAILED DESCRIPTION OF THE INVENTION

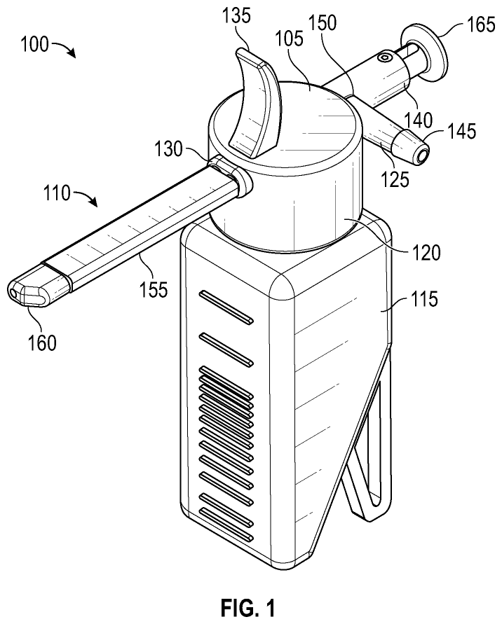

The presently preferred embodiments of the present disclosure will be best understood by reference to the figures, wherein like reference numbers indicate identical or functionally similar elements. It will be readily understood that the components of the present disclosure, as generally described and illustrated in the figures, could be arranged and designed in a wide variety of different configurations. Thus, the following more detailed description, as represented in FIGS. 1 through 4D, is not intended to limit the scope of the invention as claimed, but is merely representative of some presently preferred embodiments of the invention.

The present disclosure describes apparatuses, systems, and methods for providing an atomizer tip with a one-way valve. The design for an atomizer tip as disclosed herein is smaller, more consistent, and allows for a customizable spray profile. The design disclosed herein prevents backflow which helps prevent contamination in a liquid source that should remain pure, uncontaminated, sanitary, and/or sterile. Moreover, the disclosed design is small enough to fit inside a nostril of a child or an infant, which permits a larger range of use for an atomizer device using the disclosed atomizer tip. Since the tip is customizable and includes interchangeable components, a spray profile may be fine-tuned and adjusted for particular applications. For example, a finer mist may be obtained which may be desirable for better or faster absorption of medicament that is inserted into the nostril of a patient. As another example, changing certain characteristics of the components of the atomizer tip disclosed herein may allow for a broader (i.e., wider) spray profile or a more targeted (i.e., narrow) spray profile which may be desirable for certain applications. The variability and customizability of the atomizer tip is useful in allowing the atomizer tip to be used for a wide range of applications wherever fine misting, spraying, or dispersal of liquids is required, including medical applications, cosmetics and personal care, food and beverage, industrial and manufacturing, agriculture, household products, and scientific and laboratory uses.

FIG. 1 is a perspective view of an atomizer device 100, according to an embodiment of the present disclosure. The atomizer device 100 may include a head unit 105, nozzle component 110, and a container 115. In some embodiments, the head unit 105 includes a lid 120, a gas inlet 125, an outlet tube assembly 130, a finger support 135, and a plunger housing 140, which, in some embodiments are all integrally formed as a monolithic structure. In some instances, head unit 105 and/or atomizer device 100 is intended to be a disposable single-use atomizer device.

The lid 120 of head unit 105 is generally cylindrical with a flat top surface, from where finger support 135 extends upwards. The top and bottom edges of the lid 120, the edges of finger support 135, and any other edges of head unit 105 may be chamfered to reduce sharp edges. Lid 120 of head unit 105 may include an internal cavity configured to receive container 115 or a custom quarter-turn attachment method to ensure alignment and sealing of the container 115. Lid 120 may also include a sidewall that has a proximal end, a distal end, and a gas channel extending therebetween. In some embodiments, the proximal end of lid 120 includes the plunger housing 140 which is in fluid communication with the gas channel. The distal end of the lid 120 may include a liquid channel in fluid communication with the head unit 105, outlet tube assembly 130, and nozzle component 110. The outlet tube assembly may be attached to the head unit permanently or temporarily via any suitable attachment mechanism, including glue, standard or customized threading, elastic restraints, quick-release mechanism, one or more flexible supports fixed to the head unit, or any other conceivable manner. In some embodiments, container 115 includes a fluid reservoir in which is stored a medicament or other liquid which is intended to be administered to a patient via atomizer device 100.

In some embodiments, plunger housing 140 includes gas inlet 125 with a lumen that passes therethrough for establishing fluid communication with plunger housing 140 and the gas channel of the head unit 105. Gas inlet 125 is configured to be coupled with a source of compressed gas (not shown). In some embodiments, the compressed gas is medical air, oxygen, nitrous oxide, carbon dioxide, nitrogen, or helium. In some embodiments the compressed gas may be supplied by the available building facilities, a portable or semi-portable fixed volume compressed gas container, a handheld battery powered device, or a user-powered compressed gas device such as a handheld pump. Gas inlet 125 includes a distal end 145 having features for retaining a compressed gas line. Gas inlet 125 also includes a proximal end 150 that can be permanently or temporarily coupled to head unit 105. In some embodiments, proximal end 150 of gas inlet 125 is coupled to plunger housing 140 and is adjacent to the main body of head unit 105. The position of the gas inlet may be at angle relative to the top flat surface of the head unit 105 and at any distance from the head unit.

The nozzle component 110 may include a nozzle extension 155 and atomizer tip 160. Nozzle extension 155 may be optional in some embodiments and atomizer tip 160 may be coupled directly to head unit 105, in some cases via outlet tube assembly 130. In one or more embodiments, nozzle component 110 may couple to head unit 105 via a quick-release mechanism. Furthermore, in some embodiments, any one of the connections between atomizer tip 160, nozzle extension 155, outlet tube assembly 130, and head unit 105 may be a removable and/or interchangeable connection. For example, in some instances the connection between the various components of nozzle component 110 and head unit 105 are quick-release mechanisms that allow for a user to quickly attach and detach the various components. For example, head unit 105 may comprise a nozzle latch having a clip configured to temporarily receive and secure a latch of the outlet tube assembly 130, or outlet tube assembly 130 may comprise a latch having a clip configured to temporarily receive and secure a latch of head unit 105. In some instances, outlet tube assembly 130 may be temporarily coupled to head unit 105 through a keyed interface, wherein outlet tube assembly 130 is secured to head unit 105 by engaging the keyed interface and rotating outlet tube assembly 130 into a locked position with head unit 105. Outlet tube assembly 130 may then be unlocked and removed from head unit 105 by reversing the rotation to release the keyed interface. In some instances, the quick-release mechanism comprises a button, a lever, or a switch which may be actuated to engage and/or release outlet tube assembly 130 from head unit 105.

In some embodiments, nozzle extension 155 is rigid. In other embodiments, nozzle extension 155 is flexible, or semi-flexible thereby enabling a user to position or reposition nozzle extension 155 to achieve and retain a desired configuration. In one embodiment, nozzle extension 155 may be bendable and include a lumen for securing a wire. The wire may be embedded within the lumen along a length of the nozzle extension 155, providing structural support while also allowing a user to adjust a spray direction as needed. The wire may have malleable properties such that when formed, bent, or shaped, the wire will retain the same or similar position without rebounding back to a straight or previous position. In another embodiment, the tubing material may itself have malleable properties and an ability to retain its position without additional support. In another embodiment, the tubing is constructed of or enclosed in a series of segmented pieces with ball-and-socket style joints at each connection point allowing for the previously described adjustability. In another embodiment the atomizer tip 160 position can be controlled remotely by a mechanism near the finger support 135.

The plunger housing 140 may be configured to slidably receive a plunger 165, which when pressed in a distal direction, opens a valve which allows gas to pass through gas inlet 125, the gas channel of head unit 105, nozzle extension 155 and out atomizer tip 160.

Finger support 135 extends upwards from and is fixed to the top surface of head unit 105. Finger support 135 may be integrally formed with head unit 105. Finger support 135 may be curved and designed to accommodate a finger (i.e., an index finger) comfortably while a user holds atomizer device 100 with one hand. The finger support may also be configured as a ring through which the user's finger may be fitted to prevent accidental release of the device. The user's thumb may rest comfortably on a proximal end of plunger 165. The rest of the user's fingers may wrap around container 115, below nozzle extension 155, thus providing an ergonomic and comfortable hold on atomizer device 100. In some embodiments the container 115 or head unit 105 may include ergonomic features to further enhance comfort of the user. Additionally, when applying a force on plunger 165 to move it in a distal direction and open the valve within the head unit 105, the user's index finger may apply a counterforce to finger support 135, making it easier to apply the force to plunger 165.

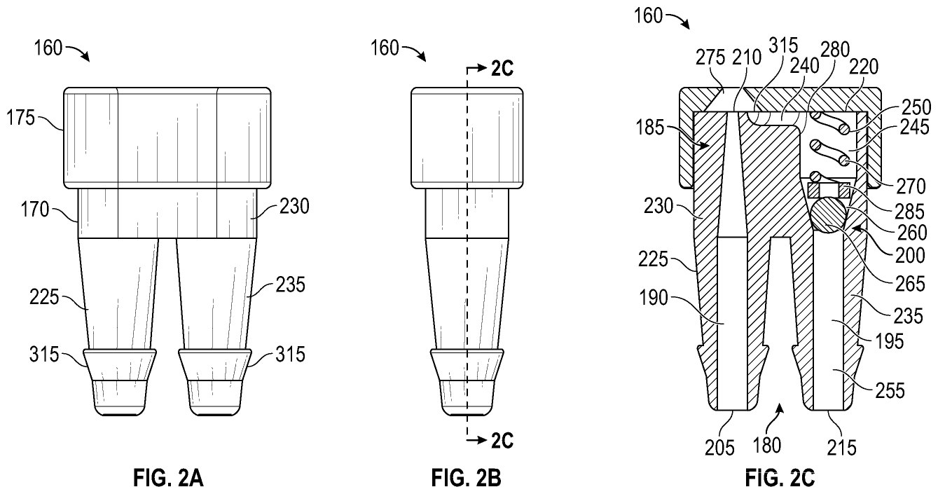

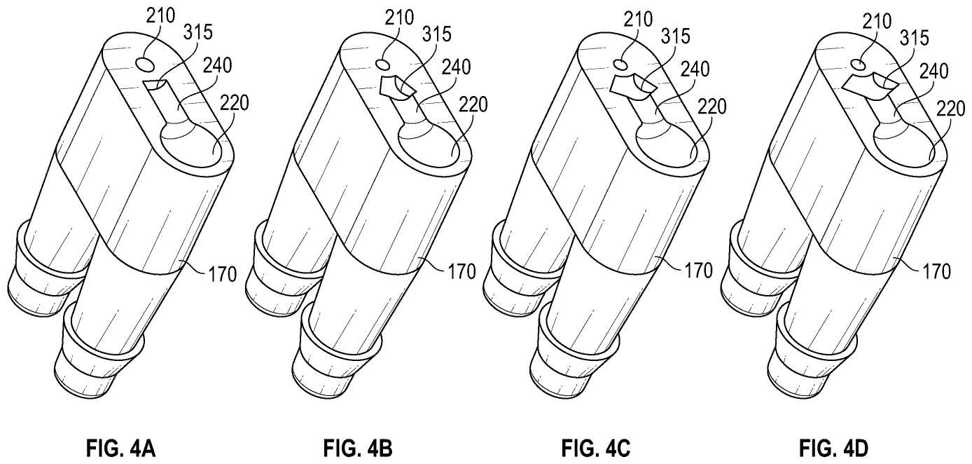

FIG. 2A is a front view of an atomizer tip 160, in accordance with one or more embodiments of the present disclosure. In some embodiments, atomizer tip 160 includes body 170 and cap 175, which are coupled together using any suitable manner. In some embodiments, body 170 and cap 175 are coupled together using an interference fit, a friction fit, a snap fit, threads, sonic weld, etc. In one or more embodiments, adhesive is applied to body 170 and/or cap 175 before being pressed together, ensuring a permanent or semi-permanent coupling. In some embodiments, a friction fit, interference fit, sonic weld, or snap fit is used without adhesive to allow different caps 175 and bodies 170 to be used together. For example, as shown in FIGS. 4A-4D, several different styles of body 170 may be used, which can lead to different outcomes in spray velocity, spray droplet size, spray direction, etc. In other embodiments not shown, cap 175 is adjustable/changeable which can change one or more dimensions of cap 175 including various nozzle dimensions

In some embodiments, body 170 includes one or more integrally formed housings for various channels that may transfer a fluid such as a gas or a liquid. For example, in one or more embodiments, body 170 includes a gas channel housing 225 and a liquid channel housing 235, each of which extend in a proximal direction from a main portion 230 of body 170. Each of gas channel housing 225 and liquid channel housing 235 may include a substantially cylindrical shape, where in some embodiments, each of gas channel housing 225 and liquid channel housing 235 includes a taper, such that a distal diameter of gas channel housing 225 and liquid channel housing 235 is greater than a respective proximal diameter, resulting in a substantially conical shape. In some embodiments, each of gas channel housing 225 and liquid channel housing 235 respectively includes a hose barb 350 at a proximal end. In some embodiments, hose barbs 350 include an annular protrusion with a step that serves to catch and secure a hose or other connection piece (e.g., nozzle extension 155) to atomizer tip 160.

FIG. 2C is a front cross-sectional view of an atomizer tip 160 depicting a cross-sectional view along line 2C shown in the side view of FIG. 2B, in accordance with one or more embodiments of the present disclosure. As shown in FIG. 2C, body 170 includes a proximal end 180, a distal end 185, a gas channel 190, a liquid channel 195, and a one-way valve 200.

In some embodiments, each of gas channel 190 and liquid channel 195 extends between proximal end 180 and distal end 185. Gas channel 190 includes an inlet 205 and an outlet 210. At least a portion (e.g., a proximal portion) of gas channel 190 is disposed within gas channel housing 225.

Liquid channel 195 includes a proximal opening 215 and a distal opening 220. At least a portion (e.g., a proximal portion) of liquid channel 195 is disposed with liquid channel housing 235. In one or more embodiments, gas channel housing 225, liquid channel housing 235 and main portion 230 of body 170 are monolithically formed as an integral unit.

In one or more embodiments, a proximal portion of gas channel 190 that is housed within gas channel housing 225 is tubular and has a constant diameter. In some embodiments, a portion of gas channel 190 (e.g., a distal portion) within main portion 230 tapers inwardly such that inlet 205 has a greater diameter than outlet 210. In some embodiments, the proximal portion of liquid channel 195 within liquid channel housing 235 is tubular and has a constant diameter. In some embodiments, the diameter of liquid channel 195 within liquid channel housing 235 is the same as the diameter of gas channel 190 within gas channel housing 225. In other embodiments, the diameter of liquid channel 195 within liquid channel housing 235 is greater than the diameter of gas channel 190 within gas channel housing 225 and vice versa.

In one or more embodiments, liquid channel 195 includes a liquid pathway that extends between proximal opening 215 and distal opening 220. Liquid channel 195 includes dimensions that are suitable to transfer sufficient liquid to be sprayed out of the atomizer tip 160. In one or more embodiments, the liquid pathway includes a horizontal lumen 240 that is in fluid communication with distal opening 220 and distal end 185 of body 170. Liquid pathway also includes a vertical lumen 245 in fluid communication with proximal opening 215 and horizontal lumen 240 having any suitable cross-section shape to perform its functions. For example, horizontal lumen 240 may comprise a cross-section selected from the group consisting of half-cylindrical, half-rectangular, semi-annular, U-shaped, and V-shaped. In some embodiments, at least some portion of horizontal lumen 240 includes a half-cylindrical channel comprising a semi-annular cross-section. In one or more embodiments, vertical lumen 245 includes a distal portion 250, a proximal portion 255, and a transition portion 260 interposed between distal portion 250 and proximal portion 255. In some embodiments, a diameter of distal portion 250 is greater than a diameter of proximal portion 255. In one or more embodiments, transition portion 260 tapers outwardly between distal portion 250 to proximal portion 255, having a proximal diameter equal to the diameter of distal portion 250 and a distal diameter equal to the diameter of proximal portion 255. In some embodiments, transition portion 260 is conical in shape, but in other embodiments, transition portion 260 includes curved walls or other shapes that serve the function of transitioning between distal portion 250 and proximal portion 255 and of serving as an element of a one-way valve 200.

In one or more embodiments, cap 175 is coupled to distal end 185 of body 170. In some embodiments, cap 175 includes an opening (i.e., a nozzle 275) that passes through a distal portion of cap 175, allowing gas and liquid to mix together and spray outward. In one or more embodiments, nozzle 275 includes any shape suitable to perform its purpose of directing the flow of gas and liquid out of cap 175 and creating a venturi vacuum effect to draw liquid out of liquid channel 195. For example, in some embodiments, nozzle 275 tapers inwardly from an inner surface 280 to an outer surface of cap 175 at an angle 320 such that the opening of nozzle 275 on inner surface has a greater width or diameter than the opening of nozzle 275 on the outer surface of cap 175. Angle 320 may be any suitable angle that allows atomizer tip 160 to perform its functions. For example, in some embodiments, angle 320 may range from zero degrees (i.e., the walls of nozzle 275 are parallel) to 150 degrees or more. In some embodiments, angle 320 may range from 30 degrees to 120 degrees or from 60 degrees to 105 degrees. Indeed, in one or more embodiments, angle 320 may be about 90 degrees. In yet further embodiments, nozzle 275 can taper outwardly from inner surface 280 to the outer surface of cap 175. In some embodiments, nozzle 275 is not symmetrical. In one or more embodiments, the walls of nozzle 275 include a curved surface (e.g., a convex or a concave surface). Inner surface 280 covers a portion of distal opening 220 of liquid channel 195 to form a distal wall and to reduce a width of distal opening 220. In one or more embodiments, a portion of distal opening 220 that is aligned with nozzle 275 is therefore uncovered by inner surface 280. The portion of distal opening that is uncovered by inner surface includes a terminal opening 315, which is in proximity to outlet 210 of gas channel 190. In one or more embodiments, the entirety of outlet 210 aligns with nozzle 275.

In some embodiments, body 170 includes one-way valve 200 which is disposed within vertical lumen 245, and in some cases within or proximate to transition portion 260. In some embodiments, one-way valve 200 is positioned between hose barb 350 of liquid channel housing 235 and cap 175. One-way valve 200 is any valve that allows fluid (e.g., liquid) to flow in a single direction (e.g., a distal direction) while preventing the fluid from flowing in the opposite direction (e.g., a proximal direction). For example, in some embodiments, one-way valve 200 is a ball valve including a ball 265 that has a diameter greater than the diameter of proximal portion 255 but less than the diameter of distal portion 250. In one or more embodiments, ball 265 is configured to substantially form a seal with transition portion 260. In additional embodiments, one-way valve 200 is one or more of the following types of one-way valves: a swing check valve, a diaphragm valve, a duckbill valve, a flapper valve, a cracking pressure valve, or a reed valve. In some embodiments, one-way valve 200 includes two or more one-way valves in series.

In one or more embodiments, one-way valve 200 includes a spring 270 having a proximal end in contact with ball 265, and a distal end in contact with inner surface 280 of cap 175. Spring 270 may be configured to bias ball 265 against transition portion 260 in a first position, thus creating a seal preventing backflow of liquid through liquid channel 195 under ambient pressure (i.e., the pressure exerted when little or no gas is flowing through gas channel 190). In a second position, ball 265 is drawn distally while spring 270 is compressed in response to a vacuum pressure being applied to horizontal lumen 240. The vacuum pressure is generated when sufficient gas is passed (i.e., forced) through gas channel 190, which causes a venturi effect and generates a negative pressure in liquid channel 195, consequently drawing liquid through liquid channel 195 from a liquid source (i.e., container 115). Once the vacuum pressure is alleviated (i.e., the gas flowing through gas channel 190 is stopped), ball 265 returns to the first position where it seals vertical lumen 245, preventing backflow of any liquid that may be in distal portion 250 or horizontal lumen 240. Spring 270 has a spring constant such that spring 270 is compressed in response to the venturi effect vacuum pressure being applied to the horizontal lumen. In some embodiments, spring 270 is integrally formed with cap 270 forming a monolithic unit, wherein spring 270 is coupled to cap 270 and extends in a proximal direction. For example, in some embodiments spring 270 is 3D printed as an integral component of cap 270. In other embodiments, spring 270 is a distinct component that is assembled into cap 270.

In one or more embodiments, a force transfer member 285 is disposed within vertical lumen 245 between spring 270 and ball 265. Force transfer member 285 may be an annular ring, in some cases with an outer diameter equal to or greater than the diameter of ball 265. Force transfer member 285 may help to evenly transfer a biasing force from spring 270 to ball 265. In some embodiments, force transfer member 285 is permanently or semi-permanently coupled to one or both of spring 270 or ball 265. In other embodiments, force transfer member 285 is freestanding within vertical lumen 245 and is held in place by the biasing force of spring 270.

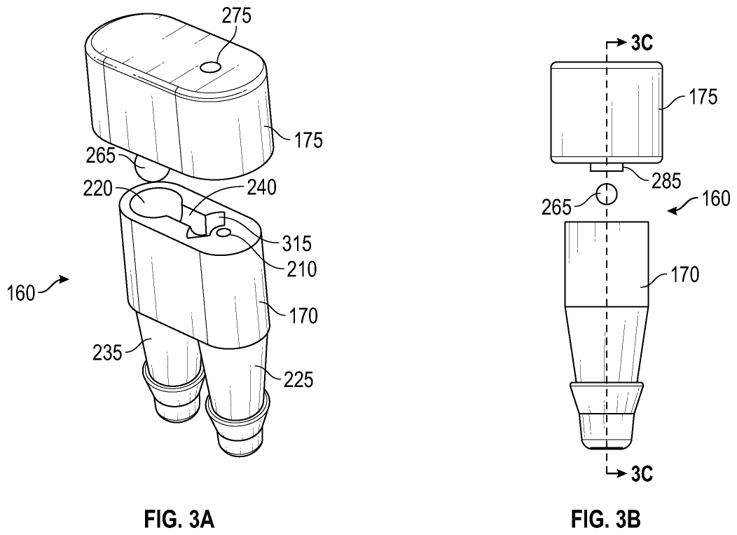

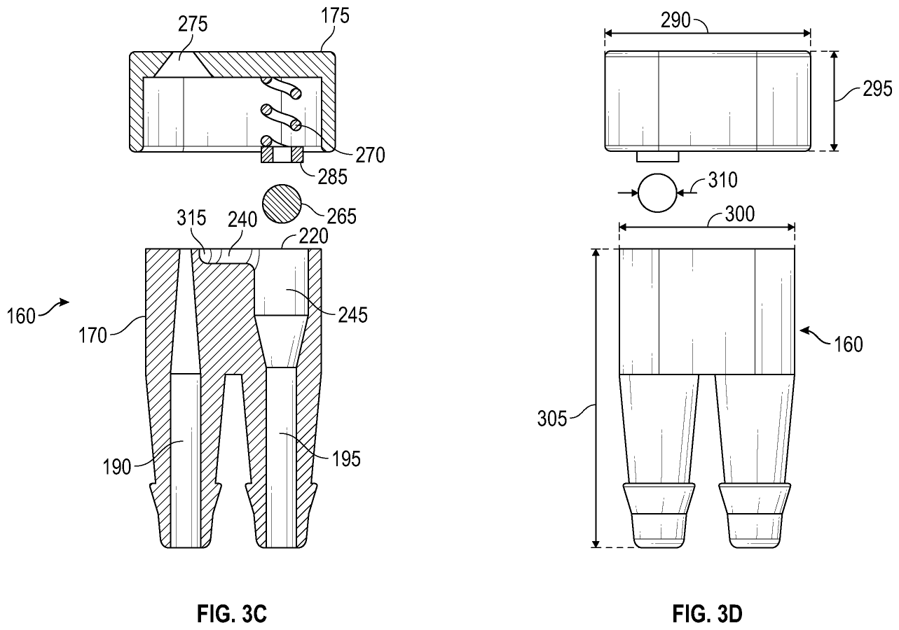

FIG. 3A is an exploded perspective view of an atomizer tip, in accordance with one or more embodiments of the present disclosure. As shown in FIG. 3A, in some embodiments, terminal opening 315 has a cross-section surface area that is greater than a cross-sectional surface area of horizontal lumen 240. In some embodiments, a cross-sectional shape of terminal opening 315 is a portion of an annular ring that circumscribes all or a portion of outlet 210 of gas channel. Such a shape allows terminal opening 315 to have a larger cross-sectional surface area that aligns with nozzle 275 of cap 175. In some embodiments, a width of terminal opening 315 is greater than a width of horizontal lumen 240.

FIG. 3B is an exploded side view of an atomizer tip, in accordance with one or more embodiments of the present disclosure.

FIG. 3C is an exploded cross-sectional view of an atomizer tip as depicted along line 3C in FIG. 3B, in accordance with one or more embodiments of the present disclosure. Atomizer tip 160 may be assembled by combining all the components shown in FIG. 3C. Body 170 may be formed initially using any suitable technique. For example, in some embodiments, body 170 is formed using injection molding, blow molding, 3D printing, or casting. Similarly, cap 175 may be separately formed using any suitable technique such as injection molding, blow molding, 3D printing, or casting. Ball 265 may then be disposed into vertical lumen 245 of liquid channel 195 through distal opening 220. Force transfer member 285 may then be inserted into vertical lumen 245 of liquid channel 195 through distal opening 220. Spring 270 may then be inserted into liquid channel 195. In the embodiments where spring 270 is integrally formed with cap 270, this step of inserting spring 270 into liquid channel 195 is combined with coupling cap 175 to body 170. Cap 175 may then be coupled to (e.g., pressed onto) body 170, forming a distal wall for liquid channel 195, and compressing spring 270 between cap 175 and force transfer member 285. In some embodiments, force transfer member 285 is optional and spring 270 is in direct contact with ball 265. In one or more embodiments, spring 270 may be fixed or attached to cap 175, force transfer member 285, and/or ball 265. In one or more embodiments, spring 270 is integrally formed forming a monolithic unit with cap 175. Furthermore, in some embodiments, an adhesive is applied to cap 175 and/or body 170 before coupling of the cap 175 to body 170 to ensure a permanent or semi-permanent coupling. In one or more embodiments, cap 175 is coupled to body 170 and fixed using sonic welding. In particular embodiments, the vacuum pressure created by the gas jet retains cap 175 coupled to body 170 with minimal gluing, sonic welding, or resistive retention (i.e., interference fit) to hold cap 170 in place. In some instances, the vacuum pressure created by the gas jet retains cap 175 to the body with only an interference fit. In some instances, the cap is retained to the body only through the vacuum pressure created by the gas jet. In some instances, the cap is retained to the body with an interference fit or through the vacuum pressure created by the gas jet, such that a user may selectively remove and/or replace cap 175 at will.

FIG. 3D is an exploded rear view of an atomizer tip, in accordance with one or more embodiments of the present disclosure. FIG. 3D includes one or more dimensions for components of atomizer tip 160. Atomizer tip 160, including its various components, includes dimensions that allow atomizer tip 160 to perform its functions of mixing a gas and liquid together using the venturi principle and spraying the gas-liquid mixture out of nozzle 275. In some embodiments, the dimensions of the various components of atomizer tip 160 are smaller than conventional atomizer tips and nozzles, which may be useful in expanding the applications of atomizer tip 160 to include medical applications for children and infants. By way of example, in some embodiments, width 290 of cap 175 is small enough that it fits inside a nostril of a small child or an infant. For example, in some embodiments, width 290 is between 3 and 15 millimeters, or any suitable subrange therein. In this regard, in some embodiments, width 290 is between 5 and 10 millimeters, or between 7 and 9 millimeters. Indeed, in one or more embodiments, width 290 is approximately 8.4 millimeters.

Cap 175 includes a suitable height 295 that allows cap 175 to couple to body 170. For example, cap 175 includes a height 295 that provides sufficient structural strength to atomizer tip 160 or provides sufficient friction to maintain the coupling between the cap 175 and body 170. For example, in some embodiments, height 295 is between 1 and 10 millimeters, or any suitable subrange therein. In this regard, in some embodiments, height 295 is between 2 and 7 millimeters, or between 3 and 5 millimeters. Indeed, in one or more embodiments, height 295 is approximately 4 millimeters.

Body 170 includes a suitable width 300 and height 305 that allows cap 175 to couple to body 170 and provide sufficient structure, stability, and spacing for gas channel 190 and liquid channel 195. For example, in some embodiments, width 300 is between 2 and 16 millimeters, or any suitable subrange therein. In this regard, in some embodiments, width 300 is between 3 and 10 millimeters, or between 6 and 8 millimeters. Indeed, in some embodiments, width 300 is 7.2 millimeters. Additionally, in some embodiments, height 305 is between 5 and 20 millimeters, or any suitable subrange therein. In this regard, in some embodiments, height 305 is between 8 and 16 millimeters, or between 11 and 13 millimeters. Indeed, in some embodiments, height 305 is approximately 12 millimeters.

Ball 265 comprises a diameter 310 that allows ball 265 to move freely within the body proximate to or within the sealing liquid channel 195 and to form a seal at or in proximity to the transition portion 260. By way of example, in some embodiments, diameter 310 is between 0.1 and 10 millimeters, and any suitable subrange therein. In this regard, in some embodiments, diameter 310 is between 0.5 millimeters and 5 millimeters, or between 1 millimeter and 2 millimeters. Indeed, in some embodiments, diameter 310 is approximately 1.5 millimeters.

FIGS. 4A-4D are each perspective views of a body of an atomizer tip, in accordance with one or more embodiments of the present disclosure. FIG. 4A shows a body 170 of atomizer tip 160 with terminal opening 315 that has a width that is equal to a width of horizontal lumen 240, whereas each of FIGS. 4B-4D shows atomizer tip 160 with terminal opening 315 that has a width that is greater than the width of horizontal lumen 240. In one or more embodiments, terminal opening includes a depth 330 suitable to allow terminal opening 315 to perform its functions. In one or more embodiments, depth 330 of terminal opening 315 is the same as the depth of horizontal lumen 240. In one or more embodiments, depth 330 is less than the depth of horizontal lumen 240. In one or more embodiments, depth 330 is less than the depth of horizontal lumen 240. In one or more embodiments, depth 330 is between 0.5 mm and 5 mm, and any suitable subrange therein. For instance, in some embodiments, depth 330 is between 1 mm and 3 mm. Indeed, in one or mor embodiments, depth 330 is approximately 2 mm. Body 170 includes any suitable distance 325 between terminal opening 315 and outlet 210 that allows the venturi effect to occur. For example, in some embodiments, distance 325 is between 0.5 mm and 2 mm, and any suitable subrange therein. In this regard, in some embodiments, distance 325 is between 0.5 mm and 1.5 mm, or between 0.75 mm and 1.25 mm. Indeed, in some embodiments, distance 325 is 1 mm.

In some embodiments, as shown in FIGS. 4B-4C, terminal opening circumscribes at least a portion of outlet 210. In some cases, distance 325 is equal at every point between terminal opening 315 and outlet 210 as terminal opening circumscribes outlet 210. In other cases, distance 325 varies at different points between terminal opening 315 and outlet 210. Terminal opening 315 may circumscribe outlet 210 in any suitable manner that allows the venturi effect to occur as gas flows out of outlet 210 to draw liquid out through terminal opening 315. In some embodiments, as shown in FIG. 4B, terminal opening 315 circumscribes outlet 210 at an angle 355, which may be any suitable angle. In one or more embodiments, angle 355 is approximately 30 degrees. In additional embodiments, as shown in FIG. 4C, outlet 210 is circumscribed by terminal opening 315 at an angle 340, which in some cases is approximately 60 degrees. In yet additional embodiments, as shown in FIG. 4D, outlet 210 is circumscribed by terminal opening 315 at an angle 345, which in some instances is approximately 90 degrees. In some embodiments, terminal opening 315 circumscribes an entirety of outlet 210 (i.e., at an angle of 360 degrees). In some embodiments, terminal opening 315 is in proximity to outlet 210, but does not circumscribe outlet 210 (i.e., circumscribes at zero degrees). In some embodiments, terminal opening 315 circumscribes outlet 210 from 5 degrees to 360 degrees, from 10 degrees to 320 degrees, from 30 degrees to 280 degrees, from 45 degrees to 225 degrees, from 55 degrees to 200 degrees, from 75 degrees to 180 degrees, from 85 degrees to 150 degrees, from 90 degrees to 130 degrees, from 85 degrees to 120 degrees, and from 90 degrees to 110 degrees.

In some instances, a greater angle allows for a greater amount of liquid to be drawn through liquid channel 195. In some embodiments, terminal opening 315 includes a non-annular or non-circular shape. In some instances, a cross-section shape, width, length, depth 330, angle, and distance 325 of the terminal opening 315 is selected to achieve a desired spray profile having a preferred spray strength and droplet size.

In some embodiments, FIGS. 4A-4D are examples of atomizer tip bodies 170 that can be interchangeably used. For example, in some embodiments, body 170 of FIG. 4A may have a spray profile for a particular application that is desired over a spray profile exhibited by body 170 shown in FIG. 4D. In this case, a practitioner can switch out body 170 of FIG. 4A with body 170 of FIG. 4D to obtain the desired spray profile. In some embodiments, cap 175 may remain the same when bodies 170 are switched out (i.e., body 170 is decoupled from cap 175 and switched out), but in other embodiments, each body 170 may include its own permanently or semi-permanently coupled cap 175, whereupon a practitioner can switch out atomizer tip 160 as a whole. In some instances, a practitioner may exchange a first atomizer tip for a second atomizer tip, wherein the second atomizer tip comprises a spray profile that is different than a spray profile of the first atomizer tip.

While not shown, in one or more embodiments, other features of atomizer tip 160 may be changed to vary a spray profile, as desired (i.e., additional tips, bodies, or caps may be interchangeable). For example, dimensions of nozzle 275 may be changed, such as a distal opening or proximal opening diameter for nozzle 275. In some cases, the taper of nozzle 275 may be changed, which can change the spray profile. In another embodiment, diameter of outlet 210 is increased or decreased, which can change the spray profile. A different spray profile may allow for smaller (i.e., finer) or larger liquid droplets, wider spray, targeted spray, distance sprayed, velocity of spray droplets leaving nozzle 275, etc.

The present disclosure may be embodied in other specific forms without departing from its structures, methods, or other essential characteristics as broadly described herein and claimed hereinafter. The described embodiments are to be considered in all respects only as illustrative, and not restrictive. The scope of the disclosure is, therefore, indicated by the appended claims, rather than by the foregoing description. All changes that come within the meaning and range of equivalency of the claims are to be embraced within their scope.

What is claimed is:

1. An atomizer tip, comprising:
a body, comprising:
a proximal end;
a distal end;
a gas channel extending between the proximal end and the distal end, the gas channel having an inlet and an outlet;
a liquid channel extending between the proximal end and the distal end, the liquid channel having a proximal opening, a distal opening, and a liquid pathway extending therebetween, the liquid pathway comprising a horizontal lumen in communication with the distal opening and distal end, and a vertical lumen in communication with the proximal opening and the horizontal lumen; and
a one-way valve disposed within the vertical lumen; and
a cap coupled to the distal end of the body and comprising a nozzle, wherein an inner surface of the cap covers a portion of the distal opening of the liquid channel to form a distal wall and reduce a width of the distal opening, wherein an uncovered portion of the distal opening forms a terminal opening and is in proximity to the outlet of the gas channel, and wherein the terminal opening and the outlet of the gas channel are aligned with the nozzle.

2. The atomizer tip of claim 1, wherein the vertical lumen comprises a proximal portion, a distal portion, and a transition portion interposed therebetween.

3. The atomizer tip of claim 2, wherein the proximal portion has a first diameter, the distal portion has a second diameter that is greater than the first diameter, and the transition portion tapers outwardly from the first diameter to the second diameter.

4. The atomizer tip of claim 3, wherein the one-way valve is a ball valve comprising a ball having a diameter that is greater than the first diameter and less than the second diameter, wherein the ball is configured to form a seal with the transition portion.

5. The atomizer tip of claim 4, wherein the one-way valve comprises a spring having a proximal end in contact with the ball, and a distal end in contact with the inner surface of the cap such that the spring biases the ball against the transition portion.

6. The atomizer tip of claim 5, wherein the one-way valve comprises a first position in which the ball is biased against the transition portion to seal the vertical lumen under ambient pressure, and a second position in which the ball is drawn distally and the spring momentarily compressed in response to a vacuum pressure being applied to the horizontal lumen.

7. The atomizer tip of claim 2, wherein the one-way valve is a duckbill valve positioned to permit one-way flow of a liquid from the proximal portion to the distal portion.

8. The atomizer tip of claim 6, wherein the spring has a spring constant configured to compress in response to a vacuum pressure being applied to the horizontal lumen, wherein the vacuum pressure results from a venturi effect when a gas is forced through the gas channel.

9. The atomizer tip of claim 6, wherein a force transfer member is disposed between the spring and the ball to evenly transfer a biasing force of the spring to the ball.

10. The atomizer tip of claim 1, wherein the terminal opening has a cross-section surface area that is greater than a cross-section surface area of the horizontal lumen.

11. The atomizer tip of claim 1, wherein a portion of the terminal opening circumscribes a portion of the outlet of the gas channel.

12. The atomizer tip of claim 8, wherein a width of the terminal opening is greater than a width of the horizontal lumen positioned between the terminal opening and the vertical lumen.

13. The atomizer tip of claim 1, wherein the nozzle tapers inwardly from the inner surface of the cap to an outer surface of the cap.

14. The atomizer tip of claim 1, wherein the inlet of the gas channel comprises a diameter that is greater than a diameter of the outlet.

15. The atomizer tip of claim 14, wherein the gas channel tapers inwardly from the inlet to the outlet.

16. The atomizer tip of claim 1, wherein the proximal end of the body comprises a first hose barb corresponding to the gas channel, and a second hose barb corresponding to the liquid channel.

17. The atomizer tip of claim 16, wherein the one-way valve is positioned between the second hose barb and the cap.

18. A method of assembling the atomizer tip of claim 5, comprising:
disposing the ball into the liquid channel;
inserting the spring into the liquid channel;
coupling the cap to the body, providing fluid communication between the liquid channel and the gas channel via the nozzle of the cap.

19. The method of claim 18, further comprising applying an adhesive between the cap and the body.

20. The method of claim 18, further comprising inserting a force transfer member into the liquid channel after disposing the ball and before inserting the spring into the liquid channel.
